(19) United States
(12) Patent Application Publication
(10) Pub. No.: US 2011/0062769 A1
(43) Pub. Date: Mar. 17, 2011

(54) TRANSMISSION UNIT HAVING TRANSLATORY DEGREE OF FREEDON

(75) Inventor: Felix Haeusler, Osnabruck (DE)

(73) Assignee: ZF FRIEDRICHSHAFEN AG, Friedrichshafen (DE)

(21) Appl. No.: 12/991,960

(22) PCT Filed: Apr. 8, 2009
(86) PCT No.: PCT/DE2009/050022

§ 371 Date: Nov. 10, 2010

(30) Foreign Application Priority Data
May 15, 2008 (DE) 10 2008 001 791.4

(51) Int. Cl. B60K 7/00; F16H 1/28

(52) U.S. Cl. 301/6.5; 475/331

(57) ABSTRACT

A transmission unit for a vehicle wheel which comprises an input shaft having an input pinion and, parallel thereto, an output shaft with an output gear wheel, where the input and output shafts are movable with respect to each other in a translatory manner. A planetary gear wheel meshes with the input pinion and the output gear wheel. The planetary gear wheel is supported on a planet carrier axle which is common to first and second planet carriers, the first planet carrier is coaxial to the input shaft and the second planet carrier is coaxial to the output shaft. The transmission unit permits the translatory decoupling between the input and the output drives with minimal construction space. It is possible, for example, to decouple wheel hub motors from the wheel suspension with respect to spring compression movements of the driven wheel, to reducing the unsprung masses of the wheel suspension.

This application is a National Stage completion of PCT/DE2009/050022 filed Apr. 8, 2009, which claims priority from German patent application serial no. 10 2008 001 791.4 filed May 15, 2008.

### FIELD OF THE INVENTION

The invention relates to a transmission unit having an input shaft and an output shaft, particularly for driving a vehicle wheel, where the input shaft and the output shaft are movable with respect to each other in a translatory manner.

### BACKGROUND OF THE INVENTION

Transmission units for transferring drive torque, in which the input shaft is movable relative to the output shaft in a translatory manner, that is, in which the input shaft and the output shaft can be shifted substantially in parallel relative to each other while simultaneously transferring torque, are known. Examples of such generic transmission units are side shafts on wheel suspensions or cardan shafts, or also special drive trains with chains or belts.

Such known transmission units with translatory degree of freedom of movement are however complex, and require significant construction space for implementing the translatory movement of the two shafts relative to each other. In addition, depending on the embodiment, these known transmission units are limited to a specific kinematic motion of the two shafts if no measures are implemented to compensate for the length of the power transferring elements (belts, chains, universal joints), which in turn, means additional design complexity.

In the example of using such transmission units for driving the wheels of a motor vehicle, initially the entire system of drive train and wheel suspension/wheel guidance must be considered, where the wheel suspension typically comprises a number of arms, for example, trailing arms, semi-trailing arms, transverse control arms, or composite beams.

The associated drive train of the motor vehicle typically comprises an internal combustion engine with a flange-mounted manual or automatic transmission, one or two input shafts and one or more differentials with the associated side shafts leading to the wheels. These component assemblies, in particular, insofar as they comprise the suspension arms and the side shafts, and therefore are associated with the wheel suspension, take up significant construction space in the area of the wheels of the motor vehicle, which is no longer available for other purposes and therefore reduces the space available for passengers, luggage or technical components.

The assemblies contained in a conventional drive train, in particular the suspension arms and the inputs shafts, cannot be arbitrarily reduced in size or shortened, because this would result in unfavorable kinematic conditions during the spring compression movements of the wheel.

The development of drive trains, or motor vehicle drives, however, is advancing in the direction of hybrid concepts. This includes, in particular, serial hybrids in which the mechanical connection between the combustion engine and the drive wheels has been eliminated. Instead, in a serial hybrid the internal combustion engine drives a generator, for example, which in turn feeds the electric motors connected to the drive wheels. A similar configuration can also be present in a purely electric vehicle where the energy is not delivered by a combustion engine, but rather from an electric energy accumulator; likewise, diverse mixed variants between the serial hybrid and the electric vehicle have been conceived and already exist.

In order to keep the number of components necessary for the transmission unit, as well as their required construction space and mass, as low as possible, it is sometimes attempted in such vehicle concepts to assign the electric traction motors directly to the wheels and to house them as close to the wheels as possible, or in the wheels themselves as wheel hub motors. In this manner, large parts of the conventional drive train can be omitted, or are replaced by lightweight electrical lines that can be placed flexibly between the energy generator and the wheel hub motors of the motor vehicle.

In addition, efforts are already being made to also house the wheel suspension itself with the associated spring-damper units in the interior of the wheel rims or in the immediate vicinity of the wheels, in order to obtain still more construction space that is otherwise required in conventional wheel suspensions for the known arm constructions.

DE 698 06 444 T2 discloses a wheel suspension that can be integrated into the rim of a wheel in which additionally, for example, electric drive motors can also be housed at least partially in the interior of the wheel rim. In this known wheel suspension, each electric drive motor is securely flange-mounted on the wheel carrier, which is why the mass of the drive motor must be added to the unsprung masses of the wheel suspension. Since the electric motors, that can be used for a wheel hub drive of a motor vehicle, have significant mass due to the required power, this significantly increases the unsprung mass of the wheel suspension, which can significantly impact riding comfort.

EP 0 270 521 A2 furthermore discloses a transmission unit with an input shaft having an input pinion and an output shaft having an output gear wheel, where the axles of the input shaft and output shaft extend in parallel. The two axles are movable in relation to each other in a translatory manner. Furthermore, a planetary gear wheel is also provided that meshes with the input gear wheel and the output gear wheel, and is supported on a planet carrier axle. The planet carrier axle is common to a first and a second planet carrier, where the first planet carrier is supported coaxially to the input shaft and the second planet carrier is supported coaxially to the output shaft. A disadvantage of this embodiment is that the input shaft and the output shaft overlap in the longitudinal direction of the shafts such that during a translatory movement of the axles relative to each other they must move past each other at a certain minimum distance, thereby disadvantageously resulting in the need for a relatively larger construction space.

### SUMMARY OF THE INVENTION

Proceeding therefrom, the object of the present invention is to provide a transmission unit, in particular, but by no means exclusively, for a vehicle wheel that overcomes the named disadvantages of the prior art. In particular, the transmission unit should make translatory decoupling between an input shaft and an output shaft possible, while taking up as little construction space as possible. In this manner, it should be possible, in particular to decouple wheel hub motors from the wheel suspension with respect to the spring compression movements of the wheel, and to thereby significantly reduce the unsprung masses of wheel suspension.

Considered initially in the known manner, the transmission unit according to the present invention—which is suited particularly, but by no means exclusively, for the drive of motor vehicle wheels—comprises an input shaft and an output shaft which is disposed parallel to the input shaft. Here, an input pinion is disposed on the input shaft, and an output gear wheel is disposed on the output shaft. In a manner that is likewise known, the input shaft and the output shaft are movable in a translatory manner, parallel to each other—or perpendicularly to their respective axis of rotation—in order to thereby compensate for, translatory displacement or distance changes between the input shaft and the output shaft while simultaneously transferring torque.

The transmission unit according to the invention, however, is characterized by a planetary gear wheel which meshes with both the input pinion and the output gear wheel. The planetary gear wheel is supported for this purpose on a planet carrier axle, where the planet carrier axle is common to a first planet carrier and a second planet carrier. Here, the first planet carrier is mounted coaxially to the input shaft and the second planet carrier is supported coaxially to the output shaft.

The transmission unit according to the invention, however, is distinguished in that the output shaft specifies translatory movement in which the input shaft and the output shaft are movable past each other on the face side, where the input shaft and the output shaft are positioned in a relative position coaxially to each other.

In other words, the planetary gear wheel is constantly guided by the two planet carriers which are coupled together by means of their common planet carrier axle, so that the planetary gear wheel permanently meshes with the input pinion and with the output gearwheel. Here, the first planet carrier, which is supported coaxially to the input shaft, ensures that the planetary gear wheel remains meshing with the input pinion, where the second planet carrier which is supported coaxially to the output shaft ensures that the planetary gear wheel remains meshing with the output gear wheel.

In contrast to a conventional planetary transmission for example, in the transmission unit, no circumferential rotation of the planet carrier takes place about its central suspension at a sun gear. Rather, the planet carrier of the transmission unit according to the invention serves to guarantee coordinated pivoting of the planetary gear wheel simultaneously about the axis of rotation of the input shaft and about the axis of rotation of the output shaft, with simultaneous permanent meshing of the planetary gear wheel with both the input pinion and the output gear wheel.

The advantage according to the invention therefore results that input and output shafts with an input pinion and an output gear wheel can be displaced in a translatory manner in parallel to each other, where the input pinion and the output gear wheel can be moved past each other on the face side, and simultaneously the torque coupling between the input pinion and the output gear wheel is maintained by means of the planetary gear wheel, and is permanently guaranteed.

Here it is particularly advantageous that the transmission unit according to the invention can be designed to be extremely compact because in principle it requires as little space as a conventional planetary transmission, for example. In comparison to the drive trains with a translatory degree of freedom known from the prior art—for example, side shafts and cardan shafts—the invention results in a significant reduction in required construction space that is merely a fraction of the construction space required in known solutions.

The invention can be initially be implemented independently of how the input pinion and output gear wheel are actually designed, provided that the common engagement of the input pinion and the output gear wheel with the planetary gear wheel is guaranteed. For example, the output gear wheel can also be a pinion that is disposed substantially in parallel to the input pinion and, also similar to the input pinion, meshes with the planetary gear wheel, where the meshing of both the input pinion and the output pinion is guaranteed by means of the two coupled planet carriers between the input pinion and the planetary gear wheel, and between the output pinion and the planetary gear wheel.

According to a particularly preferred embodiment of the invention, the output pinion is designed as a ring gear, however. At first glance, this embodiment of the invention, in particular, is similar to a planetary transmission, where the input pinion corresponds to the sun gear, the planetary gear wheel corresponds to a planetary gear of the planetary transmission, and the output gear wheel corresponds to the ring gear of the planetary transmission. In contrast to a planetary transmission, the planetary gear wheel in the transmission unit according to the invention is, however, not guided by one, but rather, two (possibly rudimentary) planet carriers, where the first planet carrier is supported coaxially to the input shaft (preferably directly on the input shaft) and the second planet carrier is supported coaxially to the output shaft (preferably directly on the output shaft), and where the two planet carriers have a common planet carrier axle that coincides with the axle of the planetary gear wheel.

The embodiment of the invention with a ring gear as the output gear wheel is particularly advantageous insofar as this allows the transmission unit to be implemented more compactly, than is already the case according to the invention. At the same time, the unimpeded translatory mobility of the input pinion within the movement space available in the ring gear enables the possible translatory relative movement of input shaft and output shaft to be maximized.

In principle, the invention can be implemented largely independently of the size and tooth ratios of the planetary gear wheel and output gear wheel provided that the gear meshing is guaranteed. According to a particularly preferred embodiment of the invention, however, the first planet carrier and the second planet carrier have the same effective radius. In other words, this means that the distance between the input shaft and the axle of the planetary gear wheel is equal to the distance between the output shaft and the axle of the planetary gear wheel, thus, the axle of the planetary gear wheel has the same distance to the input shaft as to the output shaft.

This embodiment is advantageous in that the maximum axle offset or the maximum translatory freedom of movement is attained between the input shaft and the output shaft. Moreover, the further decisive advantage results from the fact that due to geometrical reasons, no speed errors can be induced between input shaft and output shaft through arbitrary translatory movements between the input shaft and the output shaft with the scope of the freedom of movement of the transmission unit according to the invention. This is related to the fact that the planet carriers of the transmission unit, that in this case have the same effective radius, are basically swiveled by the same angular degree during translatory motion, and so induced rotational angle errors or speed errors occur only within the transmission unit, but are completely compensated for in the outward direction.

According to a further particularly preferred embodiment of the invention, the planet carriers are designed as swiveling levers each comprising two bearing positions. This embodiment also results in a particularly compact design of the transmission unit according to the invention. Thus, in this embodiment, the planet carriers are functionally reduced to their task to connect the planetary gear wheel of the transmission unit to the input shaft and the output shaft, or to pivotably support it relative to the input shaft and to the output shaft, and simultaneously to guarantee the correct distance between the planetary gear wheel and input pinion, and between planetary gear wheel and output gear wheel, and thereby the gear engagement.

First and foremost, the realization of the invention is independent from the structural implementation of the translatory relative mobility between the input and output shaft. The translatory relative mobility of the transmission unit can, in the example use with a wheel suspension, be realized by means of an arm arrangement known per se, for example.

According to a preferred embodiment of the invention, the transmission unit is characterized by the presence of an additional linear guide, however. The linear guide guarantees linear translatory relative movement between the input shaft and the output shaft, and the degree of freedom of movement between the input shaft and the output shaft is correspondingly limited to the desired translatory movement. Such a linear guide is particularly advantageous insofar as it only requires minimal construction space, in particular in comparison to arm arrangements in the case of wheel suspensions.

Proceeding therefrom in particular, according to a further preferred embodiment, the transmission unit is designed as a wheel drive, and is integrated in a wheel rim, where the output gear wheel is simultaneously connected directly to the wheel hub. Preferably, the transmission unit is designed as a wheel hub drive and connected directly to a drive motor.

An exceptionally compact wheel hub drive can be obtained in this manner that clearly has the decisive advantage of permitting completely unimpeded vertical spring compression movements of a driven wheel, without requiring drive members such as side shafts or chain drives that are typically required in this case. Moreover, the transmission unit according to the invention in this embodiment permits unencumbered—in particular, vertical—spring compression movement of the driven wheel, where simultaneously the input shaft of the wheel originating in the wheel hub does not follow the vertical movement of the wheel, but rather can be fixed in the vertical direction, and thus, for example can be supported directly at the vehicle chassis or can be connected directly to an axle drive or wheel drive.

The embodiment of the transmission unit according to the invention as a wheel hub drive having a directly connected drive motor also yields the decisive advantage that the drive motor—which is disposed e.g. directly at the wheel hub, however—need not be fixedly connected to the wheel hub or to the wheel carrier, but rather, can be disposed completely decoupled therefrom with respect to the spring compression movement of the wheel. In other words, this means that the drive motor of a wheel hub drive comprising the transmission unit according to the invention can be disposed, in particular, fixed to the bodywork or chassis, whereas the driven wheel can perform its spring compression movements uninfluenced by the drive. This eliminates the disadvantage of wheel hub drives known in the prior art, in which the drive motor is always added to the unsprung mass of the wheel suspension. As a result, the invention makes it possible to provide a wheel hub drive that offers suspension comfort comparable to that of a typical wheel suspension.

In principle, any motors can be used as drive motors of the wheel hub drive. Hydraulic motors, for example, can also be considered here. In particular when the transmission unit according to the invention is used in passenger vehicles having electric or hybrid drives, it is provided according to a particularly advantageous embodiment of the invention that the drive motor of the wheel hub drive is an electric motor.

In this manner, a highly compact electric wheel hub drive is obtained that can be supplied with current generated by a battery or an internal combustion engine with a generator. Here, the wheel hub drive can additionally comprise the described linear guide with which the vertical spring compression movements of the wheel can be handled. Overall, in this manner the construction space requirement for a driven wheel of a motor vehicle including its drive and suspension can be decisively reduced—to a fraction of the construction space required for conventional drive trains and wheel suspensions.

Here, the motor shaft of the drive motor preferably directly forms the input shaft, and the input pinion of the transmission unit is disposed directly on the motor shaft. This permits the drive motor to be disposed directly on the driven wheel, or even within the wheel rim, depending on the form and size of the drive motor and the rim.

According to a further particularly preferred embodiment of the invention, the transmission unit is disposed in a wheel carrier that is likewise designed as a transmission housing. This results in a particularly compact and robust embodiment of the transmission unit designed as a wheel hub drive, in which the gears of the transmission unit are disposed in the interior of the wheel carrier designed as a transmission housing.

The bearing housings for the bearing sleeves of the linear guide can be designed, for example, as one-piece with the wheel carrier, or can be directly connected to the wheel carrier. In this manner, the wheel carrier not only performs the task of guiding and supporting the wheel and the housing the transmission unit according to the invention, but also forms the movable part of the wheel suspension. In other words, this means that the bearing housings of the linear guide, in which the sliding surfaces or bearing sleeves of the linear guide are disposed, can be designed as one-piece with the wheel carrier or can be connected directly to the wheel carrier, thereby resulting in a torsionally rigid and lightweight design of the wheel suspension.

Especially in the case of a drive motor flange-mounted directly to a transmission unit according to the invention, there is preferably an elastic bellows between the shaft side of the drive motor and the transmission unit. In this manner, the relative movements between the drive motor disposed on the vehicle chassis and the wheel and the transmission unit, arising during spring compression of the wheel can be compensated for, wherein the input shaft of the motor and the transmission unit are simultaneously protected from environmental influences.

This being stated, it is obvious to a person skilled in the art that the kinematic principle of the invention is not limited to gear transmissions. Proceeding herefrom, the transmission unit can have friction wheels instead of gear wheels, the diameter ratios of which can be selected, in particular, proportional to the tooth count ratios of the gears of the transmission unit.

### BRIEF DESCRIPTION OF THE DRAWINGS

The invention is explained below in greater detail with reference to drawings that merely depict examples of embodiments. They show:

FIG. 1 an isometric representation of an embodiment of a transmission unit according to the present invention integrated in a wheel hub drive;

FIG. 2 the wheel hub drive with the transmission unit according to FIG. 1 with the drive motor removed;

FIG. 3 in a representation corresponding to FIG. 1 and FIG. 2, the transmission unit of the wheel hub drive according to FIG. 1 and FIG. 2 in a detail enlargement;

FIG. 4 the wheel hub drive with transmission unit according to FIGS. 1 to 3 in a schematic sectional representation;

FIG. 5 the wheel hub drive with transmission unit according to FIGS. 1 to 4, in a schematic side view, with the wheel in a complete rebound state;

FIG. 6 the wheel hub drive with transmission unit according to FIGS. 1 to 5, in a view corresponding to FIG. 5, with the wheel in a neutral state of the suspension; and

FIG. 7 the wheel hub drive with transmission unit according to FIGS. 1 to 6, in a view corresponding to FIGS. 5 and 6, with the wheel in a partially compressed state.

### DETAILED DESCRIPTION OF THE PREFERRED EMBODIMENTS

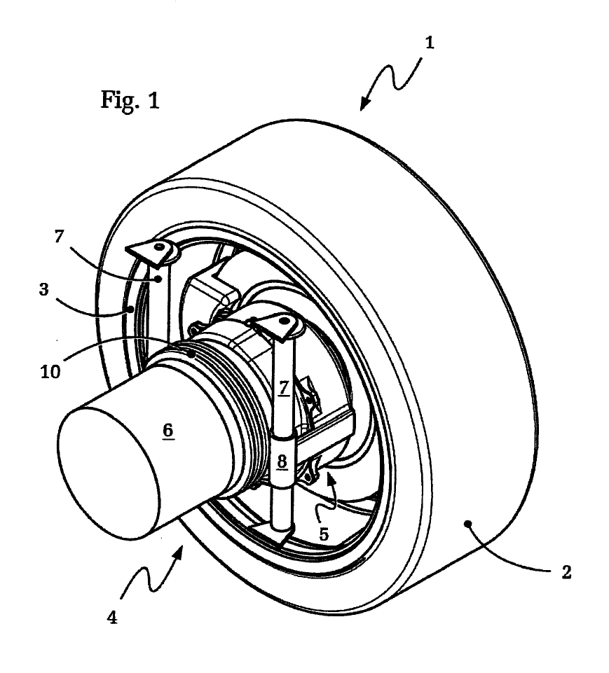

FIG. 1 shows an isometric representation of an embodiment of the transmission unit according to the present invention that is designed as a wheel hub drive or is integrated in a wheel hub drive.

A vehicle wheel 1 having a tire 2 and a rim 3 are clearly shown, as are a wheel hub drive 4 having a transmission unit 5 and a drive motor 6. The wheel hub drive 4 is equipped also with a linear guide as a wheel suspension, represented here only schematically, that in the represented embodiment has two guide rods 7 and two bearing housings 8. The bearing housings 8 are used as or contain guidance sleeves and can therefore slide vertically up and down on the guide rods 7. Spring/damping units also belonging to the wheel suspension are, for clarity, not represented in the figures.

Since the drive motor 6 is securely fastened to the (not depicted) vehicle chassis, whereas the wheel 1 with the transmission unit 5 according to the invention can implement vertical spring compression movements 9, an elastic bellows 10 is disposed between the drive motor 6 and the transmission unit 5 that elastically protects the input shaft 11 or the transmission unit 5 during the relative movements between the wheel 1 and the drive motor 6.

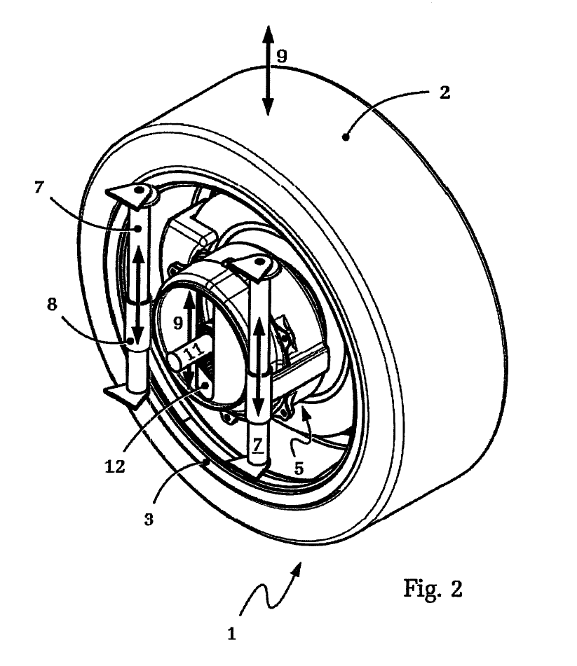

FIG. 2 shows the wheel hub drive according to FIG. 1 with the drive motor 6 removed to provide a clear view of the transmission unit 5. In addition to the elements already shown in FIG. 1, the input shaft 11 of the transmission unit 5 can in particular be recognized in FIG. 2. Using the slot 12 in the housing of the transmission unit 5, in FIG. 2, the translatory mobility 9 of the input shaft 11 relative to the housing of the transmission unit 5, or relative to the driven wheel 1 is already highlighted; see the double arrow 9 in FIG. 2.

This means that the input shaft 11 (as well as the input motor 6, the shaft of which is identical to the input shaft 11) as well as the guide rods 7 of the linear guide 7, 8 are positioned such that they are fixed to the chassis, whereas the remaining components of the transmission unit 5, the housing of the transmission unit and the driven wheel 1 can perform vertical spring compression movements 9.

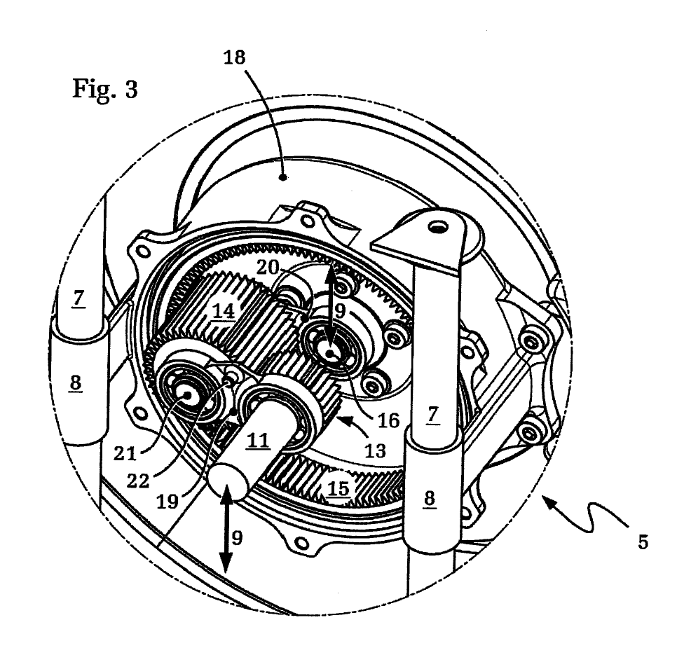

FIG. 3 shows the transmission unit 5 of the wheel hub drive according to FIG. 1 and FIG. 2 without housing covering in a detailed enlargement. The essential components of the transmission unit 5 are clearly recognizable, namely, an input pinion 13, a planetary gear wheel 14 and an output gear wheel designed here as a ring gear 15.

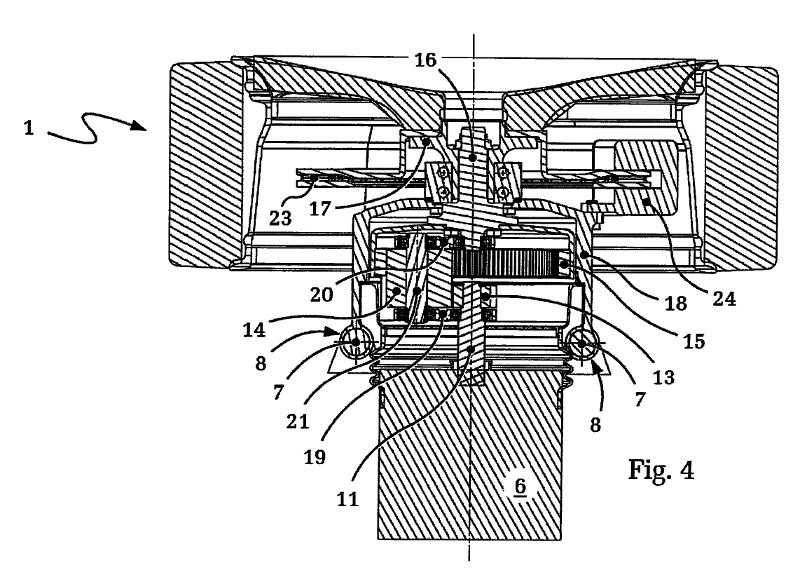

The input pinion 13 is fastened directly to the input shaft 11 of the drive motor 6 (not shown here), whereas the output gear wheel 15 is connected directly to the wheel axle 16 or wheel hub 17. The latter is highlighted, in particular, also in the detail enlargement in FIG. 4. The wheel carrier 18, that simultaneously forms or comprises the bearing sleeves or bearing housings 8 of the linear guide, is designed as a transmission housing, enclosing the output gear wheel 15.

In addition to the input pinion 13, planetary gear wheel 14 and ring gear 15, the two planet carriers 19, 20 can also be seen in FIGS. 3 and 4. The planet carriers 19, 20 in the represented embodiment are designed as swiveling levers each having two bearing positions. The first planet carrier 19 is supported on the input shaft 11 of the motor, whereas the second planet carrier 20 is supported on the wheel axle 16, which simultaneously forms the shaft of the output gear wheel 15.

The axle 21 of the planetary gear wheel 14 simultaneously forms the common planet carrier axle 21 of the two planet carriers 19, 20. Here, the first planet carrier 19 ensures a constant distance and gear engagement between input pinion 13 and planetary gear wheel 14, while the second planet carrier 20 ensures a constant distance and gear engagement also between planetary gear wheel 14 and ring gear 15. This means that the input shaft 11 and output shaft, or wheel axle 16, can perform a translatory movement 9 relative to each other in the vertical direction with respect to the drawing (see double arrow 9 in FIG. 3), where simultaneously the gear engagement of all three gear wheels 13, 14, 15 and thus, the torque transfer between the input shaft 11 and the output shaft 16 is maintained. The wheel 1 with the wheel carrier or transmission housing 18 can, therefore, perform vertical spring compression movements 9, whereas the input shaft 11 and the drive motor 6 are rigidly connected to the vehicle chassis, and therefore are part of the suspended mass of the motor vehicle.

In the case of the represented relative position of the three gear wheels 13, 14, 15—when for example, in the course of a spring compression movement input shaft 11 and output shaft 16 are positioned exactly coaxially to each other—it can, under circumstances result in a kinematic underdetermined position of the planetary gear wheels 14. In this case, the planetary wheel 14 and the two planet carriers 19 and 20, which are then positioned in parallel—similar to a planet gear in a planetary gear assembly—could rotate about the then coaxial axle of the input shaft and output shaft, which is presently undesirable because the torque transfer in this case would be interrupted and the transmission could enter an undefined state. In order to correct this kinematic underdetermination of the position of the planetary gear wheel 14, in the embodiment shown, a locking pin 22 is disposed on the first planet carrier 19. The locking pin 22 engages in a suitably formed locking gate (not depicted, for clarity) in the direct vicinity of the represented central position of compression of the input shaft 11. Due to the engagement of the locking pin 22 in the locking gate disposed, for example, in the housing cover of the transmission housing 18, it can be ensured that the first planet carrier 19 in the area of the represented central position of the input shaft 11 can perform its pivot movement only—as intended—around the planet carrier axle 21 as an instantaneous axis, and not however, around the input shaft 11. The kinematic underdeterminination of the position of the planetary gear wheel 14 in the represented coaxial position of the input shaft 11 and output shaft 16 can be eliminated due to the locking pin 22 and its engagement in the corresponding locking gate.

FIG. 4 shows the wheel hub drive with the transmission unit according to FIGS. 1 to 3 in a longitudinal section along the wheel axle 16. Here, the wheel axle 16 simultaneously forms the output shaft 16 of the transmission unit 5, and with the transmission position according to FIG. 3 and FIG. 4 is in coaxial position with the input shaft 11 of the transmission unit, which simultaneously forms the motor shaft 11 of the drive motor 6. Further, in FIG. 4 it is clearly recognizable that the housing 18 of the transmission unit, which simultaneously represents the wheel carrier, and furthermore forms or comprises the bearing housing or bearing sleeve 8 of the linear guide 7, 8.

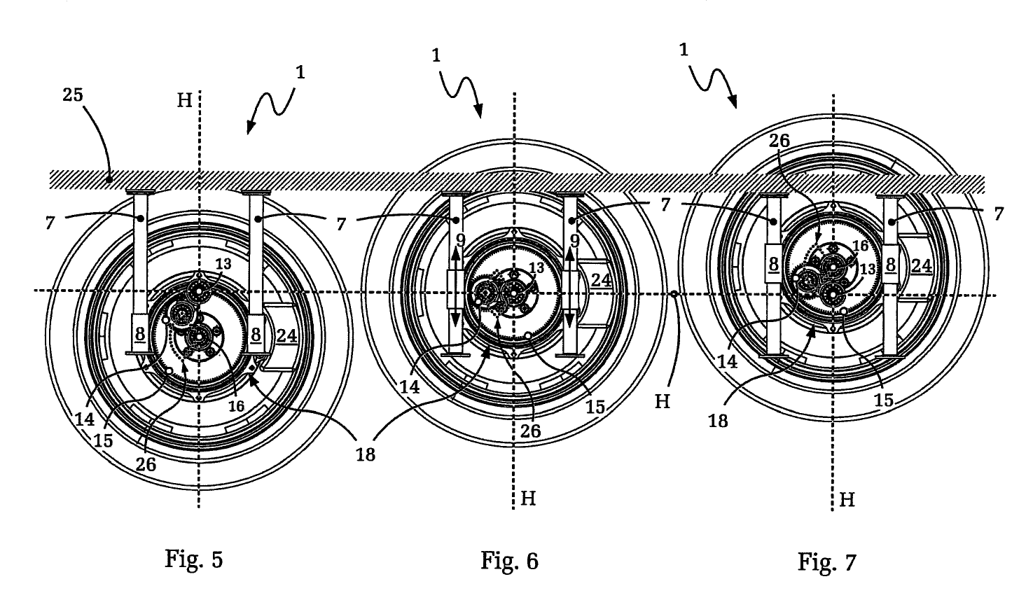

The ring gear 15 can be seen directly inside the housing wall 18 of the transmission unit 5, and it is connected in a rotationally fixed manner to the wheel hub 17 or to the wheel axis 16 of the driven wheel 1. Within the ring gear 15, and in the cut representation, the planetary gear wheel 14 can be recognized, which by means of the first planet carrier 19 is held meshing with the input pinion 13, and simultaneously by means of a second planet carrier 20 maintains its pivotable planet position (see angular segment 26 in FIGS. 5 to 7) and is held meshing with the ring gear 15. Further recognizable in FIG. 4 is a disc brake whose brake disc 23 is connected in a conventional manner to a wheel hub and to the rim, whereas the brake caliper 24 is flange-mounted directly to the transmission housing or wheel carrier 18.

In FIGS. 5 to 7 the progression of a spring compression movement of the driven wheel 1 is represented between a complete rebound (FIG. 5), neutral position (FIG. 6), and partial compression (FIG. 7). Here, the guide rods 7 are each fastened to the chassis, where the vehicle chassis is schematically indicated in the FIGS. 5 to 7 by the hatched block 25. Clearly shown is how the bearing housings or bearing sleeves 8 connected to the wheel carrier 18 can slide up and down on the guide rods 7, following the spring compression movement 9 of the wheel 1.

Also recognizable in the FIGS. 5 to 7 is the principal mode of function of the transmission unit 5 according to the invention composed of input pinion 13, planetary gear wheel 14 and output gear wheel 15. The output gear wheel designed here again as ring gear 15 is again firmly connected to the wheel axis 16, whereas the input pinion 13 is mounted directly on the input shaft 11 of the (not shown here) drive motor 6 (see FIG. 3 and FIG. 4). It can be seen clearly, in particular, with the dashed auxiliary lines H, that the input pinion 13 constantly maintains its fixed position relative to the vehicle chassis (hatched line block 25) independent of the spring compression movements 9 of the wheel 1, whereas torque transfer and gear meshing between input pinion 13 and ring gear 15 occurs by means of the planetary gear wheel 14 performing a pivot movement about the wheel axle 16. The range of the pivot movement of the planetary gear wheel 14 is indicated in FIGS. 5 to 7 by the dotted angular segment 26.

Using the depiction of the kinematics in the FIGS. 5 to 7 it is also clear that the output gear wheel 15 can be designed not only as a ring gear, as shown in the embodiment, but rather that an output pinion instead of the ring gear 15 can also be disposed directly on the wheel axle 16. In such a case, the planetary gear wheel 14 is in constant engagement—by means of the two otherwise unchanged planet carriers 19, 20—with both the input pinion 13 and the central output pinion at 16, see also FIG. 3, where instead of the ring gear 15, an output pinion (not shown) meshing with the planetary gear wheel 14 could be disposed on an extension of the wheel axle 16. The translatory mobility 9 between the output pinion and the input pinion 13 is guaranteed unchanged in this case, as the width dimension of planetary gear wheel 14 (as shown) corresponds to the sum of the widths of the input pinion 13 and the output pinion (not shown), thereby enabling input pinion 13 and output pinion to pass by each other on the face side during spring compression movements 9.

As a result, it is clear that with the invention a transmission unit is created that with a minimal construction space requirement can guarantee complete translatory decoupling between an input drive and an output drive. Due to the invention it is possible, in particular, to completely decouple wheel hub motors from the wheel suspension with respect to the spring compression movement of a driven wheel, thereby making it possible to decisively reduce the unsprung masses of the wheel suspension. The invention also makes it possible to attain exceptionally construction space-saving wheel hub drives or wheel suspensions.

The invention thus makes a groundbreaking contribution, in particular for cost reduction and construction space reduction for motor vehicle drives, for the further development of applications and for improvement of riding comfort of wheel hub drives, for example with uses in the field of hybrid drives.

### LIST OF REFERENCE CHARACTERS

1 vehicle wheel
2 tires
3 rim
4 wheel hub drive
5 transmission unit
6 drive motor
7 guide rod
8 guidance sleeve
9 spring compression movement
10 elastomeric bellows
11 input shaft, motor shaft
12 slot
13 input pinion
14 planetary gear wheel
15 output gear wheel, ring gear
16 wheel axle, output shaft
17 wheel hub
18 transmission housing, wheel carrier
19 first planet gear carrier
20 second planet gear carrier
21 planet carrier axle
22 locking pin
23 brake disc
24 brake caliper
25 vehicle chassis
26 angular segment

1-12. (canceled)

13. A transmission unit (5) for a vehicle wheel (1), the transmission unit (5) comprising:
an input shaft (11) with input pinion (13), and an output shaft (16) with output gear wheel (15),
axles of the input shaft (11) and the output shaft (16) extending parallel to one another, and the input shaft (11) and the output shaft (16) being movable in a translatory manner with respect to one an other in an orthogonal direction (9) to the axes of rotation of the input shaft (11) and the output shaft (16),
a planetary gear wheel (14), meshing with the input pinion (13) and the output gear wheel (15) and being supported on a planet carrier axis (21) which is common to a first planet carrier (19) and a second planet carrier (20),
the first planet carrier (19) being supported coaxially to the input shaft (11) and the second planet carrier (20) being supported coaxially to the output shaft (16), the output shaft (16) describes a translatory movement (9) in which the input shaft (11) and the output shaft (16) being movable past one another on a face side,
wherein in a relative position the input shaft (11) and the output shaft (16) are positioned coaxially to one another.

14. The transmission unit according to claim 13, wherein the output gear wheel (15) is a ring gear.

15. The transmission unit according to claim 13, wherein the first planet carrier (19) is supported directly on the input shaft (11) and the second planet carrier (20) is supported directly on the output shaft (16).

16. The transmission unit according to claim 13, wherein the first planet carrier (19) and the second planet carrier (20) have a same effective radius.

17. The transmission unit according to claim 13, wherein the first and the second planet carriers (19, 20) are swivelling levers which each comprise two bearing positions.

18. The transmission unit according to claim 13, wherein a linear guide (7, 8) for the translatory relative mobility (9) of the input shaft (11) and output shaft (16).

19. The transmission unit according to claim 13, wherein the transmission unit (5) is a wheel drive and is integrated in a wheel rim, and the output gear wheel is connected directly to the wheel hub.

20. The transmission unit according to claim 19, wherein the transmission unit (5) is a wheel hub drive and is connected directly to a drive motor (6).

21. The transmission unit according to claim 20, wherein the drive motor (6) is an electric motor.

22. The transmission unit according to claim 19, wherein the motor shaft forms the input shaft (11) of the transmission unit (5), and the input pinion (13) is disposed on the motor shaft.

23. The transmission unit according to claim 19, wherein the transmission unit (5) is disposed in a wheel carrier (18) designed as a transmission housing.

24. The transmission unit according to claim 19, wherein a bellows (10) is disposed between the motor housing (6) and the wheel carrier (18).
